(19) United States
(12) Patent Application Publication
(10) Pub. No.: US 2013/0001003 A1
(43) Pub. Date: Jan. 3, 2013

(54) High Capacity Motorcycle Oil Cooler

(76) Inventor: Paul Thomas Wojcik, Tucson, AZ (US)

(21) Appl. No.: 13/172,657

(22) Filed: Jun. 29, 2011

(51) Int. Cl. F01P 11/08; B62K 11/00

(52) U.S. Cl. 180/229

(57) ABSTRACT

An integrated cooling device for cooling the lubricating oil of an air cooled motorcycle engine. The motorcycle engine will have an oil pump, filter, and reservoir or sump. The device consists of a high capacity tube heat exchanger through which oil is pumped. Energy (heat) within the oil is transferred via conductive/convective diffusion from the oil, to the wall of the tube, and subsequently to the ambient air surrounding the exchanger. The removal of heat from the oil results in cooler operating temperatures which preserve the lubricating characteristics of the oil and reduce mechanical wear within the engine. The device will also function as an engine guard and critical instrument platform. The device will be mounted to the frame of the motorcycle utilizing existing mounting points. Oil from the pump will pass through the filter, through an optional thermostat or bypass valve, into the oil cooling device and back to the motorcycle oil tank or sump.

### CROSS-REFERENCE TO RELATED APPLICATION

Not applicable.

### FEDERALLY SPONSORED RESEARCH

Not applicable.

### SEQUENCE LISTING OR PROGRAM

Not applicable.

### BACKGROUND OF THE INVENTION

Originally all motorcycles were air cooled. Today many manufacturers are utilizing liquid cooled engines due to the increased efficiency; however, many motorcycles still use ambient air cooled engines. Efficient engine cooling is critical to longevity of mechanical parts. Cylinder heads are equipped with fins that conduct heat away from the engine and exchange with the surrounding air. Heat exchange with fins involves the process of conducting energy (heat) through the fin and then transferring that heat to the environment. Key components of cooling efficiency of finned, air cooled engines is surface area of the heat exchange component in contact with the ambient air and the temperature driving force (i.e. temperature difference) between the exchanger and the ambient air.

Typically air cooled motorcycles like many of the models produced by Harley Davidson Motorcycle Company of Milwaukee, Wis., are twin cylinders, four stroke, large displacement, air cooled, internal combustion engines. The lubrication/cooling circuit of these engines consists of an oil pump, oil filter, oil distribution through the engine, and oil reservoir. Heat dissipation is accomplished by conduction of heat through metal surfaces of the system to the environment outside the system (surrounding air).

The disadvantage of this type of cooling system is that it is least efficient when forced convection is absent, i.e. forced convection occurs when the motorcycle is moving and air is flowing over the hot surfaces of the engine which transfers heat from the motorcycle components to the surrounding air. When the motorcycle is not in motion, the air around the cylinder heads and fins becomes stagnant. The ambient temperature of the air in immediate contact with the heat exchange surfaces rises and the driving force for heat exchange is reduced resulting in elevation of engine temperature. If the temperature of the engine rises high enough (greater than 250 degrees F.) engine oil viscosity will be reduced and oil can be broken down resulting in loss of lubrication. As oil viscosity decreases, oil pressure drops which leads to reduced lubrication. This situation greatly increases the risk of mechanical wear and engine damage or failure.

Because the fins of the typical air cooled engine are confined to the cylinder heads, the amount of heat exchange surface area is limited and the heat exchange efficiency is reduced because of the close proximity to the heat source (the engine). This situation can be improved by moving the heat exchange surfaces away from the confined space of the cylinder head and increasing the surface area.

Heat generated by combustion and friction in internal combustion engines reduces power and increases wear on the engine and other components so keeping an engine within an optimal operating temperature is critical for engine performance and longevity.

There are a variety of ways to cool internal combustion engines. One of the more efficient but potentially complicated methods is to have a high surface area radiator through which fluid flows releasing heat to the environment. The circulating fluid can be engine oil or a different fluid e.g. antifreeze in a separate closed system. Inagaki et.al., U.S. Pat. No. 5,307,865, Hillman U.S. Pat. No. 4,445,587, Ozawa U.S. Pat. No. 4,640,341, and Fujisawa et. al. U.S. Pat. No. 4,662,470 all describe variations of the radiator style cooling system. The system can be as simple as a radiator through which engine lubricating oil is pumped resulting in cooling or more complicated involving a dedicated closed cooling circuit with an alternate fluid such as antifreeze. The latter may consist of channels in the engine through which the separate cooling fluid circulates, cooling the engine in the process. The cooling fluid is directed from the engine, through a radiator where it is cooled prior to returning to the engine. The radiator may have a cooling fan which facilitates forced convective cooling. This method of cooling is efficient but adds complexity, weight, and cost. Another negative to this type of cooling system is that the more complex systems are not easily added to an existing motorcycle.

Yamada et. al. U.S. Pat. No. 4,971,171 invented a system where a cooling fan not only forces air over a radiator style oil cooler but also forces air directly onto the cylinder head thus incorporating two forms of cooling. Gittlein U.S. Pat. No. 5,363,823 describes an oil cooling apparatus that consists of a finned housing through which engine lubricating oil flows. The apparatus is mounted between the oil filter and oil filter mounting plate. This system has simplicity and is easily installed on an existing motorcycle. The negatives of this system are limited heat exchange surface area and the location of the cooler is directly on the engine where the ambient air is hot. The location of the cooler reduces the driving force (i.e. temperature difference) which in turn reduced cooling capacity.

Another way to cool a motorcycle engine is to utilize a sealed cavity as part of the frame. Shinozaki et. al. U.S. Pat. No. 4,690,236, describes a system where engine oil is circulated through sections of the motorcycle frame. An advantage of this type of configuration is the utilization of existing functional components of the motorcycle to increase engine cooling. Also this approach does not detract from the original vehicle aesthetics and is durable by design. This method also adds oil reservoir volume which facilitates cooling. A negative aspect of this approach is that existing bikes are not easily modified to include this system.

Tritton U.S. Pat. No. 4,902,059 designed an oil cooling assembly where oil flows though the vehicle bumper. This device has the following advantages: allows the oil to cool away from the heat of the motor compartment, increases the volume of oil, mounts in a conventional manner, and functions as a bumper. The design and mounting of the bumper would need to account for the additional volume of oil to prevent overflow. Many of the positive attributes of this patent are incorporated into this invention.

Michl U.S. Pat. No. 5,244,036 invented an oil cooler specifically for motorcycle application. This cooler consists of a finned tube mounted to the down tube portion of the front frame of the motorcycle. The oil flows through the tube in ambient air and cools. Advantages of this design are simplicity, increased oil capacity, and low cost. A key disadvantage of this design is the need for exterior fins. The cooler is mounted directly behind the front wheel where the cooler can be damage by debris kicked up by the front tire or coated with material from the road which would decrease efficiency. This cooler is also mounted close to the engine where the ambient air is hot especially when the motorcycle is not moving or moving slowly.

Spurgin U.S. Pat. No. 5,887,561 invented an oil diverting system which would reroute the oil to an oil cooler when the engine's operating temperature was reached. Spurgin specified that the oil cooler could be an engine guard or other cooling device. Spurgin stated that Harley Davidson engine guards may have dimensions 80 inches or more in length with an outside diameter of 1.25 inches and discussed the multiple function attributes of engine guard oil coolers.

Kline U.S. Pat. No. 6,994,150 sought to “provide an improved integrated motorcycle engine guard oil cooler.” Kline chose the approach of adding radial fins to the vertical portion of an engine guard as well as adding a plurality of cross sectional restrictions to the interior of the engine guard hollow metal tube through which the oil would flow. Although the fins would improve the efficiency of heat exchange, this design introduces disadvantages. The fins are located away from the engine which is good for efficiency but this location can also lead to the fins being damaged by contact in close quarters, a situation common to motorcycles. This location may also cause injury to persons walking near the motorcycle as cooling fins are commonly thin, sharp protrusion of metal. Kline also states that “The successive pressure increases and pressure decreases create additional oil pressure and improves cooling.” Oil is considered an incompressible fluid and pressure changes themselves do not directly contribute to heat exchange as described by the following equation.¹

q= h̅A(Tₒᵢₗ−T_{amb})

The above equation describes the total heat flux, q, for a cylindrical heat exchanger with oil flowing through it and in a stream of air. A is the total surface area of the cylinder, h̅ is overall heat transfer coefficient, Tₒᵢₗ is the temperature of the oil, and T_{amb} is the temperature of the ambient air surrounding the cylinder. There is no pressure dependent term in the calculation of heat transfer for an incompressible fluid such as oil. These restrictions increase the load on the oil pump and decrease the oil pressure downstream from the cooler which could lead to lubrication deficiencies and premature mechanical wear and engine failure. As with Spurgin, Kline specifies and outside diameter for the engine guard of “about 1.25 inch”.

Accordingly the advantages of my invention are that the deficiencies of the existing oil coolers are addressed while maintaining the primary objective of offering a device that provides efficient engine cooling for air cooled motorcycles. The invention is multifunctional and serves as a crash bar, cooler and critical instrument platform. This invention was conceived and designed with a focus on simplicity and it is easily installed on an existing air cooled motorcycle. The structure of the oil cooler allows it to be mounted on existing frame mounting brackets of the motorcycle. The larger internal volume (significantly larger than a modified stock crash bar) results in a larger heat sink as well as increased surface area. The high surface area facilitates efficient cooling which in turn eliminates the need for cooling fins. This leads to greater durability and more desirable aesthetics. The configuration of the device and location away from the engine also increase the efficiency of heat transfer. The design includes a recession for the upper motorcycle frame to ensure clearance of front fender, forks or fork shields and signals.

### SUMMARY

The objective of this invention is to provide an improved, multifunctional, integrated motorcycle engine guard oil cooler. The design of this invention addresses the deficiencies of the existing technologies available for cooling motorcycle engines. The objectives for the design of this invention are as follows:
Improve engine cooling
Avoid complicated cooling equipment
Avoid radiator or finned style coolers due to poor aesthetics and fragile nature
Consider cost of materials and labor in design (maximize value)
Utilize existing mounting hardware on the motorcycle to facilitate installation
Avoid undesirable aesthetic changes
Design facilitates mounting of optional critical engine instrumentations
Cooling device could be multifunctional (cooler, crash bar, critical engine instruments platform).

I have invented an integrated engine guard oil cooler that consists of a hollow cavity that functions as an engine guard and oil cooler. This invention differs from other crash bar technology in that it has a high heat exchange surface area without the use of cooling fins. The internal volume is more than double that of other patented engine guard coolers. The external surface area for the suggested diameter of 1.75 inches is over 40% larger than standard engine guard coolers with a diameter of 1.25 inches. The larger volume cavity requires that the design of the device includes a recessed mounting area for the top front frame mount. This recessed mounting point allows the larger volume cavity without the cooler coming in contact with functional components of the motorcycle, mainly the signals, forks, and front fender. The increased volume cavity geometry facilitates the mounting of critical engine instruments directly to the cooler. Critical instruments are optional. The recommended instruments are oil pressure and oil temperature. The location of these instruments at the top of the oil cooler allows convenient and safe monitoring of critical engine variables.

### DRAWINGS: A BRIEF DESCRIPTION

FIG. 1 is a front side view of the oil cooler mounted to a motorcycle

FIG. 2 is a front side view of the preferred embodiment of the oil cooler

FIG. 3 is a top view of the oil cooler

FIG. 4 is a right side view of oil cooler with optional heat exchange enhancer

FIG. 5 is an oil flow diagram of the cooling system and major motorcycle components

### DRAWINGS

1 oil cooler

2 lower mounting point for crash bar or oil cooler

3 engine

4 critical instrument ports

5 oil inlet line from pump via oil filter

6 oil exit line return to oil reservoir

7 connection fitting oil outlet

8 mounting flange left side of motorcycle

9 mounting flange right side of motorcycle

10 connection fitting oil inlet

11 recessed top mounting bracket

12 critical instrument gauge

13 critical instrument gauge

14 mounting holes (left and right)

15 oil disperser

16 oil pump

17 oil reservoir

18 oil filter

19 thermostat of mechanical bypass

20 top mounting bracket clearance recess

### DETAILED DESCRIPTION

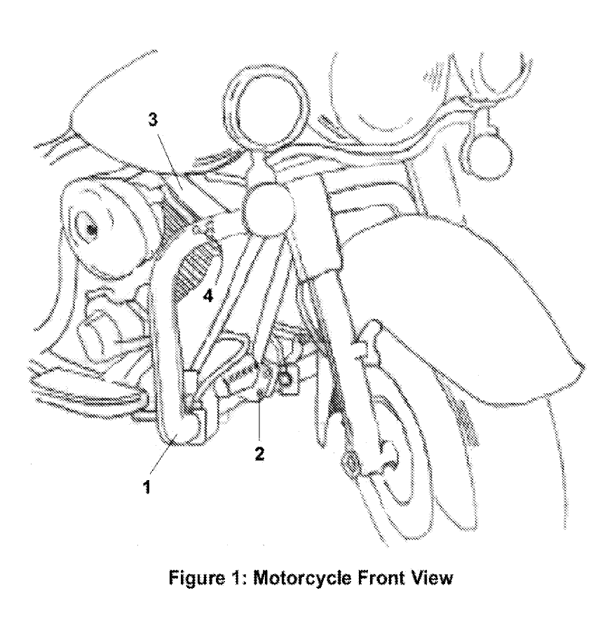

The high capacity oil cooler 1 of this invention is shown mounted to a motorcycle in FIG. 1. The cooler is fabricated from materials that are durable, machineable, and have a high thermal conductivity. Materials of this type are typically metals including steel, aluminum, stainless steel, as well as others. Cost, ease of fabrication, esthetics, durability, and thermal conductivity must all be considered when choosing a material. The external finish of the oil cooler is also a matter of preference and can be chrome, polished metal, powder coat, paint or other coatings. One of the preferred material and coatings for the oil cooler is carbon steel with a chrome or powder coated finish.

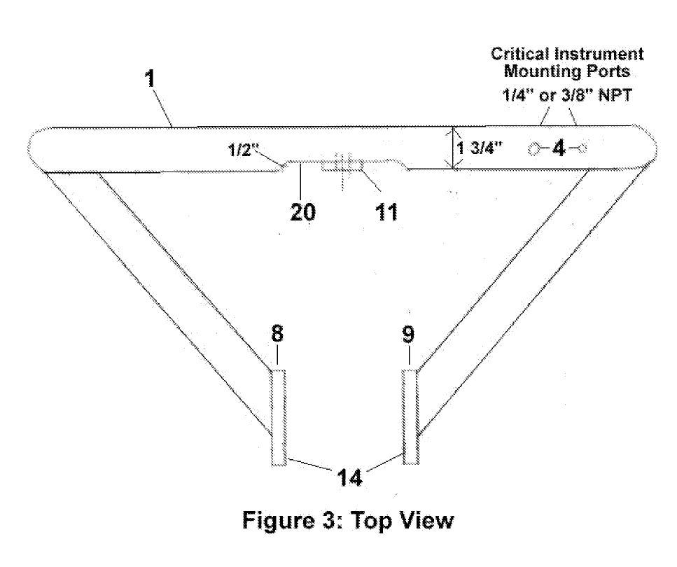

The oil cooler 1 is shown in FIGS. 1, 2, 3, and 4 as a hollow metal tube with an inlet 10 and outlet 7 and mounting hardware 8, 9, and 11. Mounting flanges 8 and 9 attach to the lower frame of the motorcycle and incorporate threaded holes into which the inlet 10 and outlet 7 connectors are mounted. The top mounting bracket 11 of the oil cooler is mounted to the upper frame of the motorcycle. The oil cooler can be attached to existing mounts for the stock crash bar which simplifies installation. The tube can be of any shape (typically cylindrical) diameter/width, or length. The preferred length is comparable to a stock crash bar (approximately 80 inches) and the diameter is larger that the 1.25 inch outside diameter of a stock crash bar. An outside diameter of 1.75 inches dramatically increases the efficiency of the cooler by increasing the external heat exchange area by greater than 40% over a stock crash bar converted to an oil cooler. The wall thickness of the tube should be 0.12 inches or thicker. With an 80 inch length and a 1.75 inch outside diameter, the tube will have a volume of approximately 2.5 quarts.

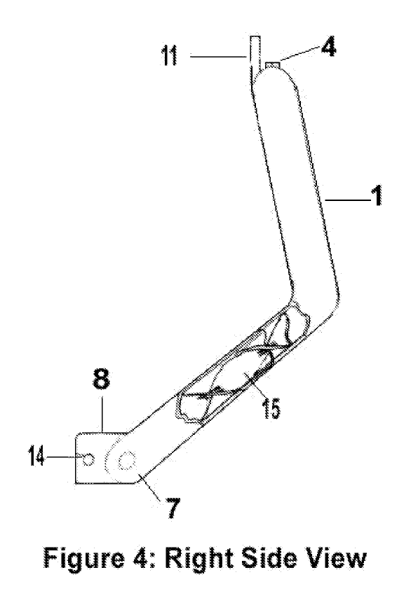

If additional cooling is required a helically twisted metal strip 15 can be mounted inside the heat exchanger 1 as shown in FIG. 4. The helical strip should be inserted into the tube prior to bending and tack welded on one end. After the tube is bent to the desired configuration the other end should be welded to the inner tube. The spiral strip should run the length of the tube and be a diameter equal to the inner diameter of the tube. This modification will increase the residence time of the oil in the tube and create a more turbulent flow condition which will result in higher heat transfer. The modification is only needed in extreme conditions and was not included on the prototype tested in Tucson, Ariz. during the summer months.

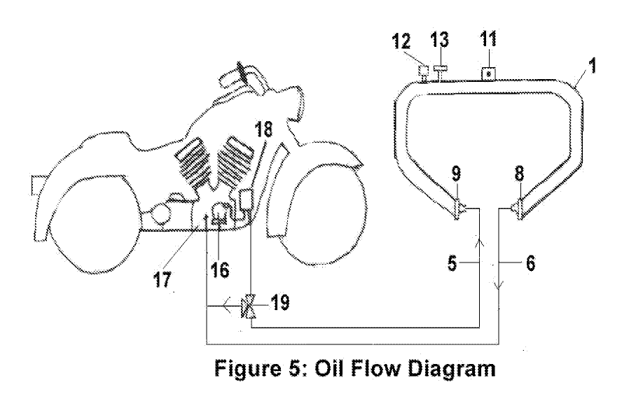

FIG. 5 shows a schematic of the oil circulation circuit of a typical air cooled motorcycle including the oil cooler 1 invented. Oil flows from an oil reservoir 17 by means of a pump 16. The oil passes through an oil filter 18 and then through a thermostat/diverter device 19. There are a variety of combination products consisting of an oil diverter and thermostat 19, sold by motorcycle parts suppliers such as J&P Cycles of Anamosa, Iowa (www.jpcycles.com). These apparatus sense the oil temperature and divert the oil directly back to the oil reservoir 17 until a predetermined operating temperature is reached, typically 180° F. Once operating temperature has been reached the diverter/thermostat 19 directs the flow to the oil cooler 1. From the cooler 1 the reduced temperature oil returns to the oil reservoir 17.

FIG. 5 shows a critical component of this invention. Because the oil cooler 1 has a larger diameter than a stock crash bar, a recessed area 20 to which the upper mounting bracket 11 is attached needs to be included in the fabrication. This recessed area 20 is 0.5 inches deep and approximately 4 inches wide. These dimensions allow the cooler to be offset towards the back to the bike which results in the location of the leading edge of the cooler to be in the same vertical plane as a stock crash bar. This offset prevents the cooler from contacting and potentially damaging the front fender, front forks, and signals. The recess 20 can be produced by flattening the rearward side of the cooler 1 in a press or by cutting out the necessary portion of the cooler and welding in a flat plate of metal.

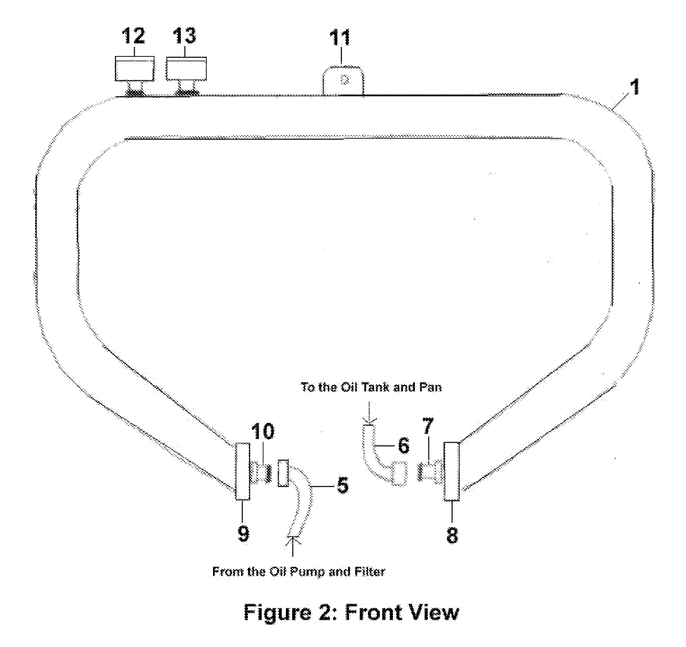

FIG. 2 shows another novel feature of this invention. On top of the cooler 1, one or more instrumentation ports 4 are included. The design of this cooler 1, by way of its larger diameter or flat areas of non cylindrical designs, allows for installation of these ports. Recommended configuration of this ports is ¼ inch NPT for the outer port and ⅜ NPT for the inner port which will allow mounting of commonly available oil pressure 12 and temperature gauges 13 respectively. The placement of these gauges on the upper horizontal portion of the device allows the rider to monitor critical engine variables in a safe and efficient manner. However, these instruments could be mounted anywhere along the entire length of the device if a more discreet placement is desired. Many Harley Davidson models do not have these instruments and after market instruments are often mounted in locations where monitoring while riding can be difficult and even dangerous.

### REFERENCES CITED

### US Patent Documents

| | | |
|---|---|---|
| 5,244,036 | Sep. 1, 1993 | Michl |
| 5,887,561 | Mar. 1, 1999 | Spurgin |
| 6,994,150 | Feb. 1, 2006 | Kline |
| 2,781,859 | Oct. 15, 1954 | Warren |
| 4,445,587 | Dec. 16, 1981 | Hillman |
| 4,640,341 | Feb. 3, 1987 | Ozawa; |
| 4,662,470 | May 5, 1987 | Fujisawa |
| 4,690,236 | Aug. 1, 1987 | Shinozaki |
| 4,902,059 | Feb. 20, 1990 | Tritton |
| 4,971,171 | Nov. 20, 1990 | Yamada |
| 5,307,865 | May 3, 1994 | Inagaki |
| 5,363,823 | Nov. 15, 1994 | Gittlein |
| 5,740,772 | Apr. 21, 1998 | Bluma |

1. White, Frank M. Heat Transfer, Addison-Wesley Publishing Company, Reading, Mass., 1984.

I claim:

1. In an air cooled motorcycle having an oil pump, oil reservoir, and oil filter, an improved high capacity engine guard, oil cooler with large internal cavity volume and large heat exchange surface area in contact with external environment, said oil cooler mounting to the left and right side of the lower front frame and the upper front frame; said oil cooler having an inlet and an outlet at the lower mounting points of the cooler.

2. The system of claim 1 wherein the new design does not contact any functional parts of the motorcycle except the 3 mounting points and 2 oil lines.

3. The system of claim 1 wherein the design allows for the mounting of instrumentation to monitor critical engine parameters.
